(19) United States
(12) Patent Application Publication
(10) Pub. No.: US 2007/0155866 A1
(43) Pub. Date: Jul. 5, 2007

(54) Moisture crosslinkable polymeric composition containing special antioxidants

(76) Inventors: Michael B. Biscoglio, Middlesex, NJ (US); Kenneth T. Devlin, Somerset, NJ (US); Mohamed Esseghir, Monroe Township, NJ (US); Laurence H. Gross, Bridgewater, NJ (US); Donald L. McDaniel JR., Manville, NJ (US); Marvin Coates JR., Piscataway, NJ (US); Salvatore F. Shurott, Freehold, NJ (US)

Correspondence Address: UNION CARBIDE CHEMICALS AND PLASTICS TECHNOLOGY;CORPORATION, P.O. BOX 1967, MIDLAND, MI, 48641-1967, US

(21) Appl. No.: 10/561,406

(22) PCT Filed: Jun. 22, 2004
(86) PCT No.: PCT/US04/19910

§ 371 Date: Dec. 16, 2005

Related U.S. Application Data
(60) Provisional application No. 60/483,269, filed on Jun. 25, 2003.

(51) Int. Cl. C08K 5/34; C08C 19/00

(52) U.S. Cl. 524/86; 524/127; 524/186; 525/342

(57) ABSTRACT

The present invention is a moisture-crosslinkable polymeric composition comprising (a) a silane-functionalized olefinic polymer, (b) an acidic silanol condensation catalyst, and (c) an antioxidant, not having a tertiary alkyl-substituted aryl or phenolic group, wherein the polymeric composition does not generate a high amount of foul-smelling or combustible gases. Alternatively, the antioxidant is substantially free of substituents vulnerable to dealkylation in the presence of the acidic silanol condensation catalyst and at conventional processing conditions. The invention also includes methods for preparing the moisture-crosslinkable polymeric composition. The moisture-crosslinkable polymeric compositions can be used as a coating and applied over a wire or a cable.

This invention relates to a moisture-crosslinkable polymeric composition that does not generate a high amount of a foul-smelling gas, a combustible gas, or both. The polymeric composition is useful for low to high voltage wire-and-cable applications.

### DESCRIPTION OF THE PRIOR ART

The use of acidic silanol condensation catalysts enhances the cure rates of moisture-crosslinkable polymeric compositions. Unfortunately, certain acidic silanol condensation catalysts such as sulfonic acid catalysts are not stable or selectively reactive as a catalyst at high temperatures (>100 degrees Celsius). As a result, the sulfonic acids may liberate sulfoxide gases or react with other additives in the polymeric composition under typical processing conditions. Some of these gases or reaction products produce strong odors, are combustible, and/or adversely affect the tensile properties of heat-aged articles made from the polymeric compositions. The resulting gases may also produce voids or surface imperfections in articles manufactured from the moisture-crosslinkable polymeric composition.

There is a need for a moisture-crosslinkable polymeric composition that does not generate a high amount of foul-smelling or combustible gases. There is a further need for the improvement to not affect adversely (a) the catalytic performance of the acidic silanol condensation catalyst or (b) the tensile properties of heat-aged articles of manufacture made from the moisture-crosslinkable polymeric composition.

### SUMMARY OF THE INVENTION

The present invention is a moisture-crosslinkable polymeric composition comprising (a) a silane-functionalized olefinic polymer, (b) an acidic silanol condensation catalyst, and (c) an antioxidant, not having a tertiary alkyl-substituted aryl or phenolic group, wherein the polymeric composition does not generate a high amount of foul-smelling or combustible gases. Alternatively, the antioxidant is substantially free of substituents vulnerable to dealkylation in the presence of the acidic silanol condensation catalyst and at conventional processing conditions. The moisture-crosslinkable polymeric compositions can be used as a coating and applied over a wire or a cable. The invention also includes methods for preparing the moisture-crosslinkable polymeric composition.

### DESCRIPTION OF THE INVENTION

The invented moisture-crosslinkable polymeric composition comprises (a) a silane-functionalized olefinic polymer, (b) an acidic silanol condensation catalyst, and (c) an antioxidant, not having a tertiary alkyl-substituted aryl or phenolic group, wherein the polymeric composition does not generate a high amount of a foul-smelling gas, a combustible gas, or both.

Suitable silane-functionalized olefinic polymers include silane-functionalized polyethylene polymers, silane-functionalized polypropylene polymers, and blends thereof. Preferably, the silane-functionalized olefinic polymer is selected from the group consisting of (i) a copolymer of ethylene and a hydrolyzable silane, (ii) a copolymer of ethylene, a hydrolyzable silane, and one or more C3 or higher alpha-olefins and unsaturated esters, (iii) a homopolymer of ethylene, having a hydrolyzable silane grafted to its backbone, and (iv) a copolymer of ethylene and one or more C3 or higher alpha-olefins and unsaturated esters, having a hydrolyzable silane grafted to its backbone.

Polyethylene polymer, as that term is used herein, is a homopolymer of ethylene or a copolymer of ethylene and a minor proportion of one or more alpha-olefins having 3 to 12 carbon atoms, and preferably 4 to 8 carbon atoms, and, optionally, a diene, or a mixture or blend of such homopolymers and copolymers. The mixture can be a mechanical blend or an in situ blend. Examples of the alpha-olefins are propylene, 1-butene, 1-hexene, 4-methyl-1-pentene, and 1-octene. The polyethylene can also be a copolymer of ethylene and an unsaturated ester such as a vinyl ester (e.g., vinyl acetate or an acrylic or methacrylic acid ester).

The polyethylene can be homogeneous or heterogeneous. The homogeneous polyethylenes usually have a polydispersity (Mw/Mn) in the range of 1.5 to 3.5 and an essentially uniform comonomer distribution, and are characterized by a single and relatively low melting point as measured by a differential scanning calorimeter. The heterogeneous polyethylenes usually have a polydispersity (Mw/Mn) greater than 3.5 and lack a uniform comonomer distribution. Mw is defined as weight average molecular weight, and Mn is defined as number average molecular weight.

The polyethylenes can have a density in the range of 0.860 to 0.970 gram per cubic centimeter, and preferably have a density in the range of 0.870 to 0.930 gram per cubic centimeter. They also can have a melt index in the range of 0.1 to 50 grams per 10 minutes. If the polyethylene is a homopolymer, its melt index is preferably in the range of 0.75 to 3 grams per 10 minutes. Melt index is determined under ASTM D-1238, Condition E and measured at 190 degrees Celsius and 2160 grams.

Low- or high-pressure processes can produce the polyethylenes. They can be produced in gas phase processes or in liquid phase processes (i.e., solution or slurry processes) by conventional techniques. Low-pressure processes are typically run at pressures below 1000 pounds per square inch (“psi”) whereas high-pressure processes are typically run at pressures above 15,000 psi.

Typical catalyst systems for preparing these polyethylenes include magnesium/titanium-based catalyst systems, vanadium-based catalyst systems, chromium-based catalyst systems, metallocene catalyst systems, and other transition metal catalyst systems. Many of these catalyst systems are often referred to as Ziegler-Natta catalyst systems or Phillips catalyst systems. Useful catalyst systems include catalysts using chromium or molybdenum oxides on silica-alumina supports.

Useful polyethylenes include low density homopolymers of ethylene made by high pressure processes (HP-LDPEs), linear low density polyethylenes (LLDPEs), very low density polyethylenes (VLDPEs), ultra low density polyethylenes (ULDPEs), medium density polyethylenes (MDPEs), high density polyethylene (HDPE), and metallocene copolymers.

High-pressure processes are typically free radical initiated polymerizations and conducted in a tubular reactor or a stirred autoclave. In the tubular reactor, the pressure is within the range of 25,000 to 45,000 psi and the temperature is in the range of 200 to 350 degrees Celsius. In the stirred autoclave, the pressure is in the range of 10,000 to 30,000 psi and the temperature is in the range of 175 to 250 degrees Celsius.

Copolymers comprised of ethylene and unsaturated esters are well known and can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range~of 5 to 50 percent by weight based on the weight of the copolymer, and is preferably in the range of 15 to 40 percent by weight. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. The melt index of the ethylene/unsaturated ester copolymers can be in the range of 0.5 to 50 grams per 10 minutes, and is preferably in the range of 2 to 25 grams per 10 minutes.

Copolymers of ethylene and vinyl silanes may also be used. Examples of suitable silanes are vinyltrimethoxysilane and vinyltriethoxysilane. Such polymers are typically made using a high-pressure process. Use of such ethylene vinylsilane copolymers is desirable when a moisture crosslinkable composition is desired.

The VLDPE or ULDPE can be a copolymer of ethylene and one or more alpha-olefins having 3 to 12 carbon atoms and preferably 3 to 8 carbon atoms. The density of the VLDPE or ULDPE can be in the range of 0.870 to 0.915 gram per cubic centimeter. The melt index of the VLDPE or ULDPE can be in the range of 0.1 to 20 grams per 10 minutes and is preferably in the range of 0.3 to 5 grams per 10 minutes. The portion of the VLDPE or ULDPE attributed to the comonomer(s), other than ethylene, can be in the range of 1 to 49 percent by weight based on the weight of the copolymer and is preferably in the range of 15 to 40 percent by weight.

A third comonomer can be included, e.g., another alpha-olefin or a diene such as ethylidene norbornene, butadiene, 1,4-hexadiene, or a dicyclopentadiene. Ethylene/propylene copolymers are generally referred to as EPRs and ethylene/propylene/diene terpolymers are generally referred to as an EPDM. The third comonomer can be present in an amount of 1 to 15 percent by weight based on the weight of the copolymer and is preferably present in an amount of 1 to 10 percent by weight. It is preferred that the copolymer contains two or three comonomers inclusive of ethylene.

The LLDPE can include VLDPE, ULDPE, and MDPE, which are also linear, but, generally, has a density in the range of 0.916 to 0.925 gram per cubic centimeter. It can be a copolymer of ethylene and one or more alpha-olefins having 3 to 12 carbon atoms, and preferably 3 to 8 carbon atoms. The melt index can be in the range of 1 to 20 grams per 10 minutes, and is preferably in the range of 3 to 8 grams per 10 minutes.

Any polypropylene may be used in these compositions. Examples include homopolymers of propylene, copolymers of propylene and other olefins, and terpolymers of propylene, ethylene, and dienes (e.g. norbornadiene and decadiene). Additionally, the polypropylenes may be dispersed or blended with other polymers such as EPR or EPDM. Suitable polypropylenes include TPEs, TPOs and TPVs. Examples of polypropylenes are described in POLYPROPYLENE HANDBOOK: POLYMERIZATON, CHARACTERIZATION, PROPERTIES, PROCESSING, APPLICATIONS 3-14, 113-176 (E. Moore, Jr. ed., 1996).

Vinyl alkoxysilanes (e.g., vinyltrimethoxysilane and vinyltriethoxysilane) are suitable silane compound for grafting or copolymerization to form the silane-functionalized olefinic polymer.

Suitable acidic silanol condensation catalysts include (a) organic sulfonic acids and hydrolyzable precursors thereof, (b) organic phosphonic acids and hydrolyzable precursors thereof, and (c) halogen acids. Preferably, the acidic silanol condensation catalyst is an organic sulfonic acid. More preferably, the acidic silanol condensation catalyst is selected from the group consisting of alkylaryl sulfonic acids, arylalkyl sulfonic acids, and alkylated aryl disulfonic acids. Even more preferably, the acidic silanol condensation catalyst is selected from the group consisting of substituted benzene sulfonic acids and substituted naphthalene sulfonic acid. Most preferably, the acidic silanol condensation catalyst is dodecylbenzyl sulfonic acid or dinonylnapthyl sulfonic acid.

Suitable antioxidants include (a) phenolic antioxidants, (b) thio-based antioxidants, (c) phosphate-based antioxidants, and (d) hydrazine-based metal deactivators. Suitable phenolic antioxidants include methyl-substituted phenols. Other phenols, having substituents with primary or secondary carbonyls, are suitable antioxidants. A preferred phenolic antioxidant is isobutylidenebis(4,6-dimethylphenol). A preferred hydrazine-based metal deactivator is oxalyl bis(benzylidiene hydrazide). Preferably, the antioxidant is present in amount between 0.05 weight percent to 10 weight percent of the polymeric composition.

In addition, the composition may contain other additives such as colorants, corrosion inhibitors, lubricants, anti-blocking agents, flame retardants, and processing aids.

In a preferred embodiment, the present invention is a moisture crosslinkable polymeric composition comprising (a) a silane-functionalized olefinic polymer selected from the group consisting of (i) a copolymer of ethylene and a hydrolyzable silane, (ii) a copolymer of ethylene, a hydrolyzable silane, and one or more C3 or higher alpha-olefins and unsaturated esters, (iii) a homopolymer of ethylene, having a hydrolyzable silane grafted to its backbone, and (iv) a copolymer of ethylene and one or more C3 or higher alpha-olefins and unsaturated esters, having a hydrolyzable silane grafted to its backbone; (b) an acidic silanol condensation catalyst selected from the group consisting of alkylaryl sulfonic acids, arylalkyl sulfonic acids, and alkylated aryl disulfonic acids; and (c) an antioxidant, not having a tertiary alkyl-substituted aryl or phenolic group selected from the group consisting of (i) phenolic antioxidants, (ii) thio-based antioxidants, (iii) phosphate-based antioxidants, and (iv) hydrazine-based metal deactivators, wherein the polymeric composition does not generate a high amount of a foul-smelling gas, a combustible gas, or both.

In an alternate embodiment, the invention is wire or cable construction prepared by applying the polymeric composition over a wire or cable.

In a yet another embodiment, the invention is a moisture crosslinkable polymeric composition comprising (a) a silane-functionalized olefinic polymer; (b) an acidic silanol condensation catalyst; and (c) an antioxidant, substantially free of substituents vulnerable to dealkylation in the presence of the acidic silanol condensation catalyst and at conventional processing conditions, wherein the polymeric composition does not generate a high amount of a foul-smelling gas, a combustible gas, or both.

### EXAMPLES

The following non-limiting examples illustrate the invention.

### Lower Explosivity Limit (LEL) for 50-Gram Samples

Three Examples of the present invention were evaluated against 6 Comparative Examples. All exemplified polymeric compositions were prepared to a weight of 50 grams and using 46.33 weight percent of AMPLIFY EA100™ ethylene ethylacrylate copolymer, 46.33 weight percent of a linear low density polyethylene (“LLDPE”), 4 weight percent of NACURE™ B201 alkyl aromatic sulfonic acid, and 3.34 weight percent of the evaluated antioxidant.

AMPLIFY EA100™ ethylene ethylacrylate copolymer is available from The Dow Chemical Company, having a melt index of 1.5 grams/10 minutes and ethylacrylate concentration of 15 weight percent. The LLDPE was a copolymer of 1-butene and ethene, having a melt index of 0.7 grams/10 minutes and a density of 0.92 grams/cubic centimeter. The NACURE™ B201 alkyl aromatic sulfonic acid is available from King Industries, Inc.

For each exemplified polymeric composition, 50 grams of the composition were placed in a sealed 32-ounce jar, having a rubber septum in its lid. The jar and its contents were heated for 30 minutes at 180 degrees Celsius. After the jars were allowed to cool to room temperature, the septa were removed and an Eagle detection meter was placed inside the jar to measure the amount of generated gas.

An RKI Instruments Eagle Series Portable Multi-Gas Detector Meter was used to measure the gas generated. The meter was calibrated to detect methane on a scale of 0 to 100 percent LEL, corresponding to 0 to 50,000 parts per million (ppm) methane. The percent LEL was reported using, the methane-gas scale as representative for all detected gases.

TABLE 1

| Example No. | Antioxidant | percent LEL |
|---|---|---|
| Example 1 | DSTDP | 7 |
| Example 2 | Lowinox 22IB46 | 8 |
| Example 3 | OABH | 9 |
| Comparative 4 | Cyanox 1790 | 40 |
| Comparative 5 | Irganox 1010 | 46 |
| Comparative 6 | Irganox 1035 | 24 |
| Comparative 7 | Irganox 3114 | 59 |
| Comparative 8 | Lowinox AH25 | 37 |
| Comparative 9 | TBM6 | 18 |

DSTDP is distearyl-3-3-thiodiproprionate available from Great Lakes Chemical Corporation. Lowinox 22IB46™ isobutylidene bis-(4,6-dimethylphenol) is an antioxidant available from Great Lakes Chemicals Corporation. OABH is oxalyl bis(benzylidiene hydrazide), a metal deactivator available from Eastman Chemical Company. Cyanox 1790™ tris(4-t-butyl-3-hydroxy-2,6-dimethylbenzyl)-s-triazine-2,4,6-(1H,3H,5H)trione is available from Cytec Industries. Irganox 1010™ tetrakismethylene(3,5-di-t-butyl-4-hydroxylhydrocinnamate)methane, Irganox 1035™ thiodiethylene-bis(3,5-di-tert-butyl-4-hydroxyhydrocinnamate), and Irganox 3114™ 1,3,5-tris[[3,5-bis(1,1-dimethylethyl)-4-hydroxyphenyl]methyl]-1,3,5-triazine-2,4,6(1H,3H,5H)-trione are available from Ciba Specialty Chemicals Inc. Lowinox AH25™ 2,5-di-tert-amylhydroquinone is available from Great Lakes Chemical Corporation. TBM6 is 4,4-thiobis(2-t-butyl-5-methylphenol) available from Great Lakes Chemical Corporation.

### Lower Explosivity Limit (LEL) for 50-Pound Samples

An Example of the present invention was evaluated against 2 Comparative Examples. All exemplified polymeric compositions were prepared to a weight of 50 pounds and contained 4.0 weight percent of NACURE™ B201 alkyl aromatic sulfonic acid. The weight percent for each component is shown in Table 2.

For each exemplified polymeric composition and following its compounding, 50 pounds of the composition at a temperature of 50 degrees Celsius were placed and sealed in a 25-kilogram foil bag, having 10 percent of its total volume as air. After a 24-hour period, an Eagle detection meter was placed inside the foil bag to measure the amount of generated gas.

TABLE 2

| Component | Example 10 | Comp. Ex. 11 | Comp. Ex. 12 |
|---|---|---|---|
| AMPLIFY EA100 ™ | 46.18 | 48.00 | 45.50 |
| LLDPE | 46.18 | 48.00 | 45.50 |
| Irganox 1010 | | | 3.33 |
| Irganox 1024 | | | 1.67 |
| Lowinox 22IB46 | 3.34 | | |
| OABH | 0.30 | | |
| percent LEL | 9 | 14 | >100 |

Irganox 1024 ™1,2-bis(3,5-di-t-butyl-4-hydroxyhydrocinnamoyl)hydrazine is available from Ciba Specialty Chemicals Inc.

What is claimed is:

1. A moisture crosslinkable polymeric composition comprising:
a. a silane-functionalized olefinic polymer;
b. an acidic silanol condensation catalyst; and
c. an antioxidant, not having a tertiary alkyl-substituted aryl or phenolic group,
wherein the polymeric composition does not generate a high amount of a foul-smelling gas, a combustible gas, or both.

2. The moisture crosslinkable polymeric composition of claim 1 wherein the silane-functionalized olefinic polymer is selected from the group consisting of (a) a copolymer of ethylene and a hydrolyzable silane, (b) a copolymer of ethylene, a hydrolyzable silane, and one or more C3 or higher alpha-olefins and unsaturated esters, (c) a homopolymer of ethylene, having a hydrolyzable silane grafted to its backbone, and (d) a copolymer of ethylene and one or more C3 or higher alpha-olefins and unsaturated esters, having a hydrolyzable silane grafted to its backbone.

3. The moisture crosslinkable polymeric composition of claim 1 wherein the acidic silanol condensation catalyst is selected from the group consisting of (a) organic sulfonic acids and hydrolyzable precursors thereof, (b) organic phosphonic acids and hydrolyzable precursors thereof, and (c) halogen acids.

4. The moisture crosslinkable polymeric composition of claim 3 wherein the acidic silanol condensation catalyst is an organic sulfonic acid selected from the group consisting of alkylaryl sulfonic acids, arylalkyl sulfonic acids, and alkylated aryl disulfonic acids.

5. The moisture crosslinkable polymeric composition of claim 4 wherein the organic sulfonic acid is selected from the group consisting of substituted benzene sulfonic acids and substituted naphthalene sulfonic acids.

6. The moisture crosslinkable polymeric composition of claim 4 wherein the organic sulfonic acid is dodecylbenzyl sulfonic acid.

7. The moisture crosslinkable polymeric composition of claim 4 wherein the organic sulfonic acid is dinonylnapthyl sulfonic acid.

8. The moisture crosslinkable polymeric composition of claim 1 wherein the antioxidant is selected from the group consisting of (a) phenolic antioxidants, (b) thio-based antioxidants, (c) phosphate-based antioxidants, and (d) hydrazine-based metal deactivators.

9. The moisture crosslinkable polymeric composition of claim 8 wherein the antioxidant is isobutylidenebis(4,6-dimethylphenol).

10. The moisture crosslinkable polymeric composition of claim 8 wherein the antioxidant is oxalyl bis(benzylidiene hydrazide).

11. The moisture crosslinkable polymeric composition of claim 1 wherein the antioxidant does not adversely affect the catalytic performance of the acidic silanol condensation catalyst.

12. A wire or cable construction prepared by applying the moisture crosslinkable polymeric composition of claim 1 over a wire or cable.

13. A moisture crosslinkable polymeric composition comprising:
a. a silane-functionalized olefinic polymer selected from the group consisting of (i) a copolymer of ethylene and a hydrolyzable silane, (ii) a copolymer of ethylene, a hydrolyzable silane, and one or more C3 or higher alpha-olefins and unsaturated esters, (iii) a homopolymer of ethylene, having a hydrolyzable silane grafted to its backbone, and (iv) a copolymer of ethylene and one or more C3 or higher alpha-olefins and unsaturated esters, having a hydrolyzable silane grafted to its backbone;
b. an acidic silanol condensation catalyst selected from the group consisting of alkylaryl sulfonic acids, arylalkyl sulfonic acids, and alkylated aryl disulfonic acids; and
c. an antioxidant, not having a tertiary alkyl-substituted aryl or phenolic group selected from the group consisting of (i) phenolic antioxidants, (ii) thio-based antioxidants, (iii) phosphate-based antioxidants, and (iv) hydrazine-based metal deactivators,
wherein the polymeric composition does not generate a high amount of a foul-smelling gas, a combustible gas, or both.

14. A moisture crosslinkable polymeric composition comprising:
a. a silane-functionalized olefinic polymer;
b. an acidic silanol condensation catalyst; and
c. an antioxidant, substantially free of substituents vulnerable to
dealkylation in the presence of the acidic silanol condensation catalyst, wherein the polymeric composition does not generate a high amount of a foul-smelling gas, a combustible gas, or both.

15. A method for preparing a moisture crosslinkable polymeric composition comprising the step of admixing
a. a silane-functionalized olefinic polymer;
b. an acidic silanol condensation catalyst; and
c. an antioxidant, not having a tertiary alkyl-substituted aryl or phenolic group,
wherein the polymeric composition does not generate a high amount of a foul-smelling gas, a combustible gas, or both.
